(19) United States
(12) Patent Application Publication
(10) Pub. No.: US 2008/0294853 A1
(43) Pub. Date: Nov. 27, 2008

(54) Method and System for Pinpointing Memory Leaks

(76) Inventors: Gururaja Kowlali, Bangalore (IN); Satyam Kandula, Bangalore (IN)

Correspondence Address: HAMILTON, BROOK, SMITH & REYNOLDS, 530 VIRGINIA ROAD, PO BOX 9133, CONCORD, MA, 01742-9133, US

(21) Appl. No.: 11/753,933

(22) Filed: May 25, 2007

(51) Int. Cl. G06F 12/00

(52) U.S. Cl. 711/154

(57) ABSTRACT

A method and a system configured for dynamically pinpointing information relating to occurrences of memory leaks. A first set of machine instructions received as input at a system and executable by a processor of the system thereby generating a second set of machine instructions from the first set of machine instructions in a main memory of the system. While executing the second set of instruction, an additional memory is allocated from a heap memory when the second set of instructions creates a heap allocated memory. The additional memory is configured to store a reference count indicating number of memory location comprising addresses of the heap allocated memory. The reference count approach is used to indicate when a memory leak has occurred.

### FIELD OF THE INVENTION

This invention relates to a method and system for execution of software for accessing memory and specifically pinpointing memory leaks for software.

### BACKGROUND OF THE INVENTION

Memory Leaks are one of the most common errors in programs (e.g. C/C++ programs). Typically memory leaks are caused when a block of memory is allocated to a program and its corresponding pointer is lost before that block is freed. There are several tools available which are configured to detect memory leaks. These tools track memory operations of the programs and memory related calls such as malloc( ), realloc( ) and free( ). There are different approaches which are used for memory leak detection. For example,
a) Source code instrumentation tools like Insure++, which automatically put checks in the source code.
b) Object Code instrumentation like PurifyPlus for leak detection, which checks code inserted into the object file/executable statically, and subsequently the instrumented code is run to obtain the results.
c) Dynamic instrumentation like Valgrind, in which the object code instrumentation occurs during run-time.

Typically, memory leaks are detected by wrapping the calls to malloc( ), realloc( ) and free( ), and scanning the entire memory space of the program at the end of the program to detect whether there are any references to the allocated blocks. Typically, tools that are used for detecting memory leak use a so called mark-and-sweep algorithm at the end of each execution. Along with a leak error, the tool also reports a call-stack of the point where the block is allocated. However, this information provided by the tools is typically insufficient for developer to detect how a memory leak has occurred. A disadvantage is that the developer needs to further analyze using debuggers to detect the root-cause of the memory leak. In some instances, the debugger may be used multiple times to keep track of variables which store a value of the leaked memory, where the value gets copied to and where the value gets replaced with a value of some other variable. A further disadvantage is that if the code base is large, and a pointer to the allocated block is used at several instances, it becomes rather complex for the developer to detect the root-cause.

Providing call-stack information about the place where the pointer to the leaked block is lost enables the developer to detect the root-cause associated with the memory leak relatively much faster. Further, reporting the memory leak when it actually occurs rather than at the end of the program execution, helps the developers to detect a set of actions of an application that caused the memory leak. Reporting the memory leak when it actually occurs would require tracking four parameters:
a) The memory block that is allocated,
b) Every pointer assignment:
   i) If the value which is copied (i.e., one of RHS of an assignment) is interesting (points to a malloc block).
   ii) If the value which is assigned to (i.e., LHS of an assignment) is interesting (points to a malloc block).
c) Whenever the variable(s) goes out of scope. For example, when a malloc block address was stored in local variable or parameter and function exits.
d) The memory block that is freed.

Currently two tools provide this type of information. Dynamic Memory Solutions (DMS) has a tool Dynamic Pinpoint for leak pinpointing (http://www.dynamic-memory.com/leakcheck_d.php), which uses dynamic instrumentation to detect and pin-point memory leaks. Dynamic Pinpoint does leak pinpointing in two passes:
i) In the first pass, the memory leak blocks are detected, allocation stack for the block is detected and a token is generated.
ii) In the second pass, using the generated token, the tool tracks all valid pointers to a leaked memory block. Dynamic Pinpoint keeps track as each pointer leaves its scope or has its value change. When a last valid value is lost, the memory block has leaked. The exact line where the memory leak occurred is determined and reported.

Jonas Maebe et. al., in “Precise Leak Detection of memory leaks” (http://www.cs.virginia.edu/woda2004/maebe.pdf) provides an approach where leaked memory blocks were allocated, lost and where a last references of these memory blocks was created. A dynamic instrumentation approach at machine code level to track all pointers to allocated blocks of memory is used. All the events discussed above to report the last place where the memory has leaked is tracked as follows
i) Tracks start of each malloced block.
ii) Store information about every malloc block, and use hashing to access this information when the pointer values are checked for assignment and out-of-scope cases as discussed previously.
iii) Uses reference counting. Keep a reference count for every malloc block. Increments the count when the value is copied, and decrements the count when the value is trashed or the variable having the malloc block goes out of scope.
iv) Report memory leak when the reference count of any of the block reaches zero.
   A disadvantage is that this approach tracks only the beginning of the malloc block, and memory leaks are reported even though there is a pointer to the block which points to the middle of the block.

### For Example:

```
Class_A* Alloc_block( )
{
    char* * ptr = malloc(sizeof(Class_A)+20);
    return (Class_A*)(ptr+20);
}
void Free_block(Class_A* ptr)
{
    char *ptr = (char *)ptr;
    free (ptr−20);
}
```

These kinds of examples are typically seen in constructors of C++ program classes. When this approach is used for the example, a memory leak is reported for every block when it returns from the function Alloc_block( ). Further, all the copies that occur using a return value of Alloc_block( ) are not tracked.

A disadvantage with developing applications in C/C++ is that memory leaks are often more serious than with other programming languages, because C/C++'s pointer and memory management facilities make it difficult to build large, robust programs. A further disadvantage is the difficulty in tracking down programming bugs and many other such parameters being directly tied to the manner in which executable code is created from source code and to the inadequacies of the current development tools. Yet a further disadvantage is that monitoring which requires complete coverage to work correctly cannot be implemented through only the compiler for memory-access related errors.

Without a way to improve the method and system for monitoring and pinpointing memory leaks, the promise of this technology may never be fully achieved.

### SUMMARY OF THE INVENTION

The invention provides a method and a system for monitoring memory management by dynamically pinpointing information relating to occurrences of memory leaks. The method includes receiving a first set of machine instructions which are executable by a processor of a system and configured to generate a second set of machine instructions from the first set of machine instructions in a main memory of the system. While executing the second set of instruction, an additional memory is allocated from a heap memory when the second set of instructions creates a heap allocated memory. The additional memory is configured to store a reference count indicating number of memory location comprising addresses of the heap allocated memory. The reference count can be incremented and decremented depending on a respective operation performed by the second set of instruction. When a value associated with the reference count is zero, a memory leak is indicated. Other embodiments are also discussed.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 illustrates an exemplary embodiment of a workflow 100 for receiving a first set of machine instruction and generating a second set of machine instruction.

FIG. 2 illustrates an exemplary embodiment of the status bits defining the page table, which are used to detect the memory leaks.

FIG. 3 illustrates an exemplary embodiment the additional area where the reference count is stored.

FIG. 4 illustrates an exemplary embodiment adding instruction to the runtime function 140 of FIG. 1.

FIG. 5 illustrates an exemplary embodiment of a system 500 that implements the methods as described in FIGS. 1-4.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. Where reference is made in any one or more of the accompanying drawings to steps and/or features, which have the same reference numerals, those steps and/or features have for the purposes of this description the same function(s) or operation(s), unless the contrary intention appears. The following detailed description is, therefore, not to be taken in a limiting sense, and the scope of the present invention is defined only by the appended claims.

This invention relates to pinpointing information of memory leaks, typically while executing machine instructions when and where the leak exactly happened. Pointers pointing to entire heap allocated memory (hereinafter also referred to as a malloc( ) block) are tracked rather than as conventionally done where only the beginning of the pointers are tracked. Page tables are introduced to efficiently track the memory allocated. A page table is a structure that typically contains an array of 2 bits for every byte of memory during the execution of the program. A reference count approach using the page tables to track every copy, deallocation and/or dereferencing and variables that are going out of scope in a given application is used to pinpoint the memory leaks in one embodiment of this invention. It should be apparent to a person skilled in the art that this invention does not deal with pinpointing memory leaks related to source code implementation.

The reference count information of each malloc( ) block contains the total number of memory locations pointing to that particular block. This count gets incremented for a copy, decremented for a deallocation, decremented for dereferencing and decremented for variables going out of scope. The reference count is maintained using a counter which stores the reference counts as an integer number (positive or zero). As the reference count is being incremented and decremented when the memory is being accessed, the reference count may reach a value of zero. A memory leak is indicated and/or reported when the reference count value is zero. Along with reporting the memory leak, the call stack of the executing code when the reference count was decremented to zero, is also indicated to the user. This reference count is stored in an additional memory area for every malloc( ) block. For every pointer pointing to any part of malloc( ) block, the pointer is backtracked till the beginning of the malloc( ) block, and then backtrack again by a fixed value to obtain the address of the reference count for that malloc( ) block. The invention is mainly related to tracking pointers pointing to memory locations)within a heap allocated memory using the page table structure rather than only start of heap allocated memory.

To begin with, an object file is first expanded by inserting additional instructions to obtain a second object file. After inserting the additional instructions, offsets are checked and modified, if necessary, to reflect any new positions of the preexisting instructions, such that the expanded code can execute properly. In one embodiment additional offsets in symbol tables, data relocation tables and instruction relocation tables are updated in the same general manner as the other offsets. The basic method of the code expansion is well known to a person skilled in the art. The formation of new instructions from original set of instructions is derived from in accordance with the present invention.

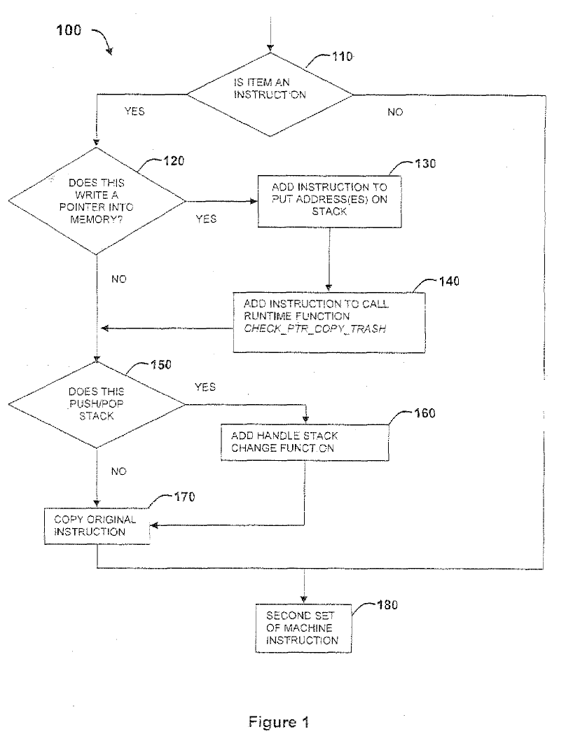

FIG. 1 illustrates an exemplary embodiment of a workflow 100 for formation of instructions in the original object file and additional instructions which monitor the memory accesses by the instructions in the original object file. In 110 it is determined whether a processing item input is data or instruction. No modification is done if the item is data. If the processing item is instruction, in 120 the instruction is checked whether the data with size of address to a memory location is written into a memory location. If the check yields a value true result (e.g., “YES” branch of decision block 120), then in 130 and 140, additional instructions to make a call to the run-time routine check_per_copy_trash, which, during execution, checks for the appropriate status bits, modifies the reference count and is configured to signal errors if required. If the check is false (e.g., “NO” branch of decision block 120), control passes to 150. In 150, the instruction is checked whether the instruction pushes or pulls the stack memory. If the result is true (e.g., “YES” branch of decision block 150), in 160, additional calls to the run-time routine handle_stack_change, which, during execution, is configure to set the appropriate status bits in the stack memory, modify the reference count and signal errors if required. If the check is false (e.g., “NO” branch of decision block 150), control passes to 170. In 170, the original instruction is copied. The second object file is linked with an extra library file including functions specially designed for memory monitoring to detect memory leaks when it actually occurs, to create an executable. When the second executable is executed, the additional memory monitoring instructions are executed along with the original program, which reports the memory leaks, using the reference counting algorithm described in the rest of the document.

Consider the following program indicating a source code and the corresponding assembly code

| Source Code | | Assembly Code | |
|---|---|---|---|
| void leakfunc( ) | | leakfunc: | |
| { | -- 1 | pull stack for local | -- 1 |
| char *ptr = malloc(10); | -- 2 | variables | |
| char *ptr2 = malloc(10); | -- 3 | movei 10, $arg1 | -- 2 |
| char *ptr3 = ptr2; | -- 4 | call malloc | |
| ptr2 = 0; | -- 5 | store $ret1, addrofptr | |
| } | -- 6 | movei 10, $arg1 | -- 3 |
| | | call malloc | |
| | | store $ret1, addrofptr2 | |
| | | load $reg1, addrofptr2 | -- 4 |
| | | store $reg1, addrofptr3 | |
| | | movei 0, $reg1 | -- 5 |
| | | store $reg1, addrofptr2 | |
| | | pop the stack | -- 6 |
| | | return | |

The lines of the source code numbered from 1-6 are also shown as equivalently numbered lines in the assembly code. The function leakfunc( ) of the source code allocates 10 bytes, twice, in heap memory. The pointers that are pointing to the heap allocated bytes in heap memory is copied to local variables.

The source code contains a simple function written in C language with the following steps
i) Start of the function.
ii) 10 bytes are allocated in heaps and its pointer is copied to per.
iii) 10 bytes are allocated in heap and its pointer is copied to ptr2.
iv) pointer ptr2 is copied to pointer ptr3.
v) pointer ptr2 is set to 0.
vi) Function returns
   It should be apparent that the program may be written either in C or C++ programming language, or other similar programming languages.

The assembly code corresponding to the source code function defined has the following steps.
i) Allocate some space in stack to store local variables.
ii) Move 10 as an argument to the function malloc. Call function malloc Write the value which is returned by function malloc to memory location of pointer (per).
iii) Move 10 as an argument to the function malloc. Call function malloc Write the value which is returned by function malloc to memory location of per.
iv) Read the value of memory location pointed to by ptr2 and put in processor register reg1 Write the value of reg1 into the memory location of ptr2.
v) Move 0 into processor register reg1 Write the value in register reg1 into memory location of ptr2
vi) Pop the stack. Return back to caller function

The assembly code generated above from the source code is provided as input to the instrumentation engine, as described previously in FIG. 1, to obtain a instrumented code as follows:

| Assembly Code | | Instrumented Assembly Code | |
|---|---|---|---|
| leakfunc: | | leakfunc: | |
| pull stack for local variables | -- 1 | pull stack for local variables | -- 1 |
| movei 10, $arg1 | -- 2 | call handle₁₃ stack_change | |
| call malloc | | movei 10, $arg1 | -- 2 |
| store $ret1, addrofptr | | call malloc | |
| movei 10, $arg1 | -- 3 | move $ret1, $arg1 | |
| call malloc | | move addrofptr. $arg2 | |
| store $ret1, addrofptr2 | | call check₁₃ ptr_copy_trash | |
| load $reg1, addrofptr2 | -- 4 | store $ret1, addrofptr | |
| store $reg1, addrofptr3 | | movei 10, $arg1 | -- 3 |
| movei 0, $reg1 | -- 5 | call malloc | |
| store $reg1, addrofptr2 | | move $ret1, $arg1 | |
| pop the stack | -- 6 | move addrofptr2. $arg2 | |
| return | | call check_ptr_copy_trash | |
| | | store $ret1, addrofptr2 | |
| | | load $reg1, addrofptr2 | -- 4 |
| | | move $reg1, $arg1 | |
| | | move addrofptr3. $arg2 | |
| | | call check_ptr_copy_trash | |
| | | store $reg1, addrofptr3 | |
| | | movei 0, $reg1 | -- 5 |
| | | move $reg1, $arg1 | |
| | | move addrofptr3. $arg2 | |
| | | call check_ptr_copy_trash | |
| | | store $reg1, addrofptr2 | |
| | | pop the stack | -- 6 |
| | | call handle_stack_change | |
| | | return | |

The assembly code highlights (indicated in bold) are the instructions of interest for the instrumentation engine where the calls to the function check_per_copy_trash are made in 140.

As described previously, for every pointer store instruction in the algorithm, where the pointer store instruction is defined as a store instruction which writes pointer size data into a memory location, the following is performed
i) Add instructions to put value of a source register and address of destination memory location into the argument registers.
ii) Add instruction to make a call to check_per_copy_trash.
   The instrumentation engine also added additional code to insert instructions for making calls to handle_stack_change. For every function, to use local variables, the program makes use of stack.

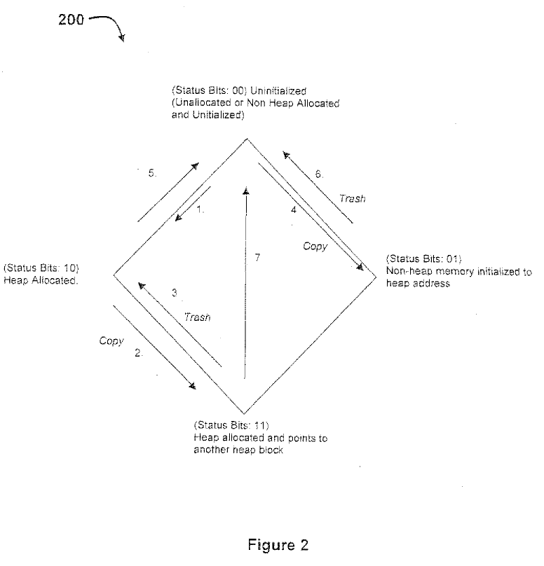

FIG. 2 illustrates an exemplary embodiment of status bits that are used to detect a memory leak defining a page table, and also shows the state transition diagram. Each entry in the page table indicates the state of the corresponding memory location. The state can be one of following:
1. uninitialized state, i.e., unallocated or non heap allocated memory and unitialized indicated by the Status Bits 00.
2. Heap Allocated memory, indicated by the Status Bits 10,
3. Heap Allocated and points to another Heap Allocated memory, indicated by the Status Bits 11.
4. Non-Heap Allocated Memory initialized to Heap Allocated Memory, indicated by the Status Bits 01.
   The arrows indicate the transition of states as the memory modifying instructions are executed. The arrows indicated by numeric value do not indicate any particular logical flow but have the steps following meaning
1. Heap Allocate: When the pointer is Heap Allocated using calls to malloc( ), realloc( ) etc.
2. Heap Address assigned to another heap allocated block: When the address of the heap block is assigned to point to another heap block (considered as Copy).
3. Heap Address does not point to any heap allocated block: When a heap allocated block which used to point to another heap block is updated to another value which is not a heap address and which doesn't point to the same heap block (considered as Trash).
4. Non-heap memory initialized to contain a heap address (considered as Copy).
5. Deallocate: When the heap block gets deallocated
6. Non heap memory which was pointing to a heap block is updated to a value which doesn't point to heap block or going out of scope (considered as Trash).
7. Deallocate: When the heap block gets deallocated

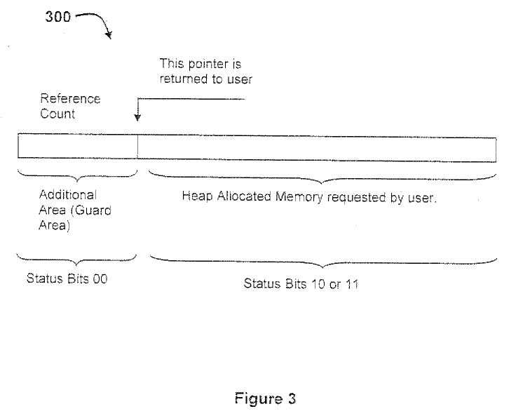

FIG. 3 illustrates an exemplary embodiment of creating additional memory 300, along with every heap allocated memory and indicating the status bits information (page table) stored for this memory. For every heap allocated memory (created using malloc( ) or realloc( )), an additional memory (guard area) is created which can store the reference count for that malloc( ) block. The heap allocated calls (malloc( ) and realloc( )) are intercepted, to create the additional memory. The address which points to the user area of the memory (just after the additional area) is returned to the function making the of malloc( ) function call. The status bits of the additional memory area are set to 00, implying that the heap allocated and initialized or unallocated. The status bits for the rest of the heap allocated block are set to either 10 or 11. For the malloc( ) block, the status bits are always set to 10. For the realloc( ) block, the status bits are set to 10 or 11 depending on the status bits of previously allocated memory.

For any given address which is part of a malloc( ) block, the following algorithm is used to get the address of the reference count, the reference count being maintained in the additional area. If the status bits of the given address are 10 or 11, then the given address is decremented, until the status bits of that address become 00. Subsequently, the address is decremented by a fixed offset to obtain the address of reference count of that malloc( ) block. Thus the pointers which point to any part of the malloc( ) block are easily tracked.

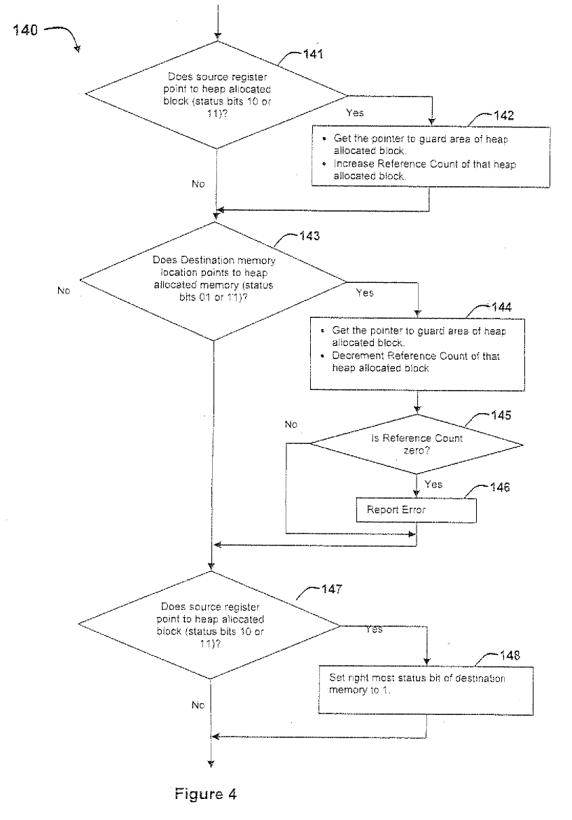

FIG. 4 illustrates an exemplary embodiment of adding instruction(s) to call a runtime function 140 of FIG. 1. A check is first made in 141 to determine if the source registers points to the heap allocated memory (heap allocated block), where the status bits have the state 10 or 11. If this check is valid or true (e.g., “YES” branch of decision block 141), the control is transferred to 142 where, the pointer pointing to the heap allocated memory is fetched from an additional memory area for that heap allocated memory (as described in FIG. 3) and the reference count stored in the guard area is incremented for that heap allocated memory and control is transferred to 143. In 141, if the check is false or fails (e.g., “NO” branch of decision block 141), the control is transferred to 143, where it is determined if the destination memory location points to a heap allocated memory having the status bits 01 or 11. If the check is true (e.g., “YES” branch of decision block 143), control is transferred to 144, where the pointer pointing to the relevant heap memory to the fetched from the guard area and the reference count is decremented for that heap allocated block. Next, in 144 a check is performed to determine if the reference count is zero, if the reference count is zero, then in 146, an error is reported as a memory leak has occurred. If the check in 145 and/or 143 fails (e.g., “NO” branch of decision block 143 and 145, respectively), control is transferred to 147, where a cheek is made to determine if the source register points to a heap allocated block, with status bits 10 or 11. If the check is true, the in 148 the status bits of the destination memory are set to 11 if its previous status bits are 10, and to 01 if its previous status bits are 00 and the function returns. Therefore by, setting the status bits of the destination memory location for each of the operations performed on the memory and allocating an additional guard memory to store the reference count, for each malloc( ) block, and by decrementing or incrementing the reference count for each operations that is performed on the memory, and when the reference count has a value zero, a memory leak is detected and reported to the user.

In the function handle_stack_change the status bits of the stack are set to 00 (uninitialized and non-heap allocated), for both stack push and stack pop operation. For the stack pop instruction, for every memory location which is now no longer part of stack, it is checked whether the status bits are 01 (i.e. points to malloc( ) block). If this is true, then the reference count stored in the guard area of that malloc( ) block is decremented. An error is reported if the reference count is zero.

If the heap allocated memory is freed or reallocated using calls to free( ) or realloc( ), the status bits of every address in the block which is freed or reallocated is checked. If any of the status bits is 11 (which means heap allocated block pointing to heap allocated block), the reference count of that heap allocated block to which this is pointing to, is decremented. A memory leak error is reported if the reference count is zero.

As described previously in para [0023], the following interpretations are assigned with reference to the instrumented code described previously in para [0024]. When Step (i) is executed, the function handle_stack_change is called. This function puts the state bits of memory locations pointing to all local variables used in the function to 00 (Non-heap allocated and Un-Initialized).

In step (ii), for every call to a heap allocated (malloc( )), the state bits of the memory locations of heap allocated block is set as 10 (Heap Allocated). Before writing the address of memory location pointing to heap allocated block to the memory location pointing to the local variable ptr2, the function check_per_copy _trash is called. Since the source register points to a malloc ( ) block, the reference count for that heap allocated block is incremented. The memory location where reference count is stored (guard area), is at a fixed offset from the beginning of heap allocated block. At this point the reference count of the first heap allocated block is set to 1. Also, the state bits of destination address (which is the local variable per) is set to 01 (non-heap allocated and initialized).

In step (iii), a second call to malloc( ) is made, and as above, the following are performed. First the reference count of second heap allocated block is set to 1. Next, the state of destination address (which is the local variable ptr2), is set to (1 (non-heap allocated and initialized). In step (iv), the value of ptr2 is copied to ptr3 where, the value of local variable ptr2 is read into the register reg1. Another call to check_ptr_copy_trash is made with reg1 as source register. Notably, since the state of source register is 10 (Heap Allocated), the reference count of second heap allocated is incremented to 2, and the state of destination address (which is local variable ptr3), is set to 01 (non-heap allocated and initialized).

In step (v), a value of 0 is copied to ptr3. Since the state of value in destination memory location (ptr2) is 01 (Non-heap memory, pointing to heap address), the reference counter of second heap allocated block is decremented to 1. In step 6, the function handle_stack_change is called. The stack which is popped contains the memory locations of following local variables: per, ptr2 and ptr3. Since the value in per and ptr3 has state 01 (H-leap Allocated), the reference counter for first heap allocated block is decremented to 0, and this indicated a memory leak has occurred and memory leak can be report as an error of the first block. The reference count for the second heap allocated block is decremented to 0, and a memory leak for the second block is also report.

In general, the method for memory management configured for dynamically pinpointing information relating to occurrences of memory leaks in accordance with this invention first comprises receiving as input a first set of machine instructions executable by a processor thereby generating a second set of machine instructions from the first set of machine instructions in a main memory. While executing the second set of instruction allocating an additional memory from a heap memory when the second set of instructions create a heap allocated memory, the additional memory (guard area) is configured to store a reference count indicating number of times any memory location, which can be either from the stack or heap or data, comprising addresses of the heap allocated memory. When the reference count value in the guard area for a particular heap allocated memory has a value zero, a memory leak has occurred and is reported.

In a further embodiment, the reference count is incremented when a memory location comprises an address of the heap allocated memory is copied to a second memory location; the second memory location is different from the memory location. In a Further embodiment, the reference count is decremented when the memory location contains an address of the heap allocated memory is overwritten by another value, the value not the address of the heap allocated memory. In a further embodiment, the reference count is decremented when a memory location, which can be a reference to the stack or heap, contains an address of the heap allocated memory is de-allocated. In yet a further embodiment when the heap allocated memory is de-allocated and if any memory location in the heap allocated block contains address of any other heap allocated block, decrementing the reference count of the other heap allocated block. In a further embodiment, when the stack is popped and the memory which is no longer in stack contains the address of heap allocated block, the reference count of the heap allocated block is decremented.

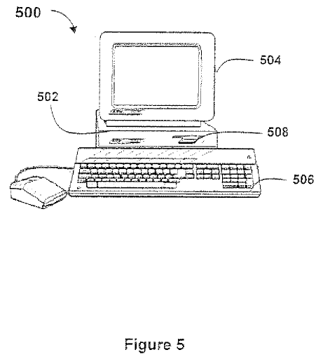

FIG. 5 illustrates an exemplary embodiment of a system 500 such as a computing system, which can advantageously implement the method as claimed and indicated in FIGS. 1-4. The system 500 in FIG. 5, preferably a processing system or a computing system, include and are not limited a variety of electronic devices such as desktop computers, application servers, web servers, database servers and the like and portable electronic devices such as mobile phones, personal digital assistants (PDAs), pocket personal computers, laptop computers, and the like, which are capable of executing software such as scripts involving at least a processor and a memory. It should be apparent to a person skilled in the art that any device, e.g. electronic devices, portable electronic devices, handheld electronic devices and the like, which includes at least a processor and a memory configured execute scripts falls within the scope of the present invention.

FIG. 5 illustrates an exemplary embodiment of a system 500 with at least a processor and a memory in which the present invention may be implemented is depicted in accordance with a one embodiment. The system 500 depicted includes a system unit 502, which further includes essential hardware components such as a microprocessors, memory, connectors, system bus, power unit etc (some of which are not shown in the figure), a video display terminal 504, an input device 506, the input device including a keyboard, mouse, a joystick, touchpad, touch screen, trackball, microphone, etc., and storage devices 508, which may include floppy drives and other types of permanent and removable storage media. Although the depicted representation shows a stand alone system 500, further embodiments of the present invention may be implemented in other types of systems 500, coupled over a network. For example a wired network, wireless network work or a combination thereof. The system 500 also preferably includes a graphical user interface (GUI) that may be implemented by means of systems software residing in computer readable media in operation within the system.

The memory associated with any system 500 is typically is an electronic holding place for instructions and/or data accessed, such as a semiconductor device e.g. random access memory (RAM), such that microprocessor of the system 500 can access the instruction and/or data rather quickly. When the computing system is in normal operation, the memory usually contains the main parts of the operating system and some or all of the application programs and related data that are being used by the computing system. Accessing data via the memory is faster than reading from a hard drive, so having a larger RAM makes it quick to retrieve recently accessed files, applications, and other data. Further, all programs must be run through the memory before they can be used. The system unit 502 typically containing these components is used for processing the software, in this case the scripts. The input device 506 is to record the user input and data may be entered via this input device 506 to perform specific functions. The video display terminal 504 is used to display the results to the user, for example the recorded input, the changed input, the associated actions, the responses etc.

In one embodiment, the system 500 comprising at least a processor and a main memory capable of executing machine instruction, wherein the software executed is a as described previously. The machine instruction is executed on the processor by performing suitable operations on the memory as described previously. The system is configured for memory management and for dynamically pinpointing information relating to occurrences of memory leaks. The system is configured to receive as input a first set of machine instructions executable by a processor thereby generating a second set of machine instructions from the first set of machine instructions in a main memory. While executing the second set of instruction allocating an additional memory from a heap memory when the second set of instructions create a heap allocated memory, the additional memory (guard area) is configured to store a reference count indicating number of memory location, which can be either from the stack or heap or data comprising addresses of the heap allocated memory. When the reference count value in the guard area for a particular heap allocated memory has a value zero, a memory leak has occurred. Other features and aspects of the reference count, specifically increment and decrementing, have been discussed previously.

In a further embodiment, a signal representing a readable signal that can be executed on a system, wherein the readable signal bearing media and transmitted over a network is capable of being implemented on the system for memory management which is configured for dynamically pinpointing information relating to occurrences of memory leaks. The signal comprises a first set of machine instructions received as input by the system and executable by a processor of the system thereby generating a second set of machine instructions from the first set of machine instructions in a main memory of the system. While executing the second set of instruction allocating an additional memory and tracking a reference count stored in the additional memory for operations performed on the heap memory as described previously, indicated a memory leak has occurred when the reference count value is zero.

The system preferably include and are not limited a variety of portable electronic devices such as mobile phones, personal digital assistants (PDAs), pocket personal computers, laptop computers, desktop computers, application servers, web servers, database servers and the like. It should be apparent to a person skilled in the art that any electronic device which includes at least a processor and a memory can be termed a client within the scope of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware and software comprising several distinct elements.

1. A method for memory management configured for dynamically pinpointing information relating to occurrences of memory leaks, the method comprising: receiving as input a first set of machine instructions executable by a proeessor, and generating therefrom a second set of machine instructions from the first set of machine instructions in a main memory; and
while executing the second set of instructions:
allocating an additional memory from a heap memory when the second set of instructions create a given allocation of heap allocated memory, the additional memory being configured to store a reference count indicating a number of memory locations that comprise an address within the given allocation of heap allocated memory;
modifying the reference count when there is a use of any memor location within the given allocation of the heap allocated memory during execution of the second set of instructions, the modifying of the reference count being capable of including modification for a memory location that is not at the start of the given allocation of the heap allocated memory; and
indicating a memory leak when a value associated with the reference count is zero.

2. The method of claim 1, wherein the reference count is incremented when a memory location comprising an address of the given allocation of the heap allocated memory is copied to a second memory location, the second memory location being different from the memory location.

3. The method of claim 1, wherein the reference count is decremented when a memory location comprising an address of the given allocation of the heap allocated memory is overwritten by another value, the value not being an address within the given allocation of the heap allocated memory.

4. The method of claim 1, wherein the reference count is decremented when a memory location comprising an address within the given allocation of the heap allocated memory is de-allocated.

5. The method of claim 1, wherein, when the given allocation of the heap allocated memory is de-allocated, if any memory location in the heap allocated block that is to be de-allocated comprises an address of any other heap allocated block, the reference count of the other heap allocated block is decremented.

6. A system for dynamically pinpointing information relating to occurrences of memory leaks, the system comprising:
a processor;
a computer readable medium coupled to the processor; and
computer code encoded in the computer readable medium and executable by the processor to cause the processor to:
receive as input a first set of machine instructions executable by the processor and generate therefrom a second set of machine instructions from the first set of machine instructions in a main memory; and
while executing the second set of instructions:
to allocate an additional memory from a heap memory when the second set of instructions create a heap allocated memory, the additional memory being configured to store a reference count indicating a number of memory locations that comprise an address within the given allocation of heap allocated memory;
to modify the reference count when there is a use of an memory location within the given allocation of the heap allocated memory during execution of the second set of instructions, the modifying of the reference count being capable of including modification for a memor location that is not at the start of the given allocation of the heap allocated memory; and
to indicate a memory leak when a value associated with the reference count is zero.

7. The system of claim 6, further comprising software encoded in the computer readable medium and executable by the processor to cause the processor to:
increment the reference count stored in the additional memory when a memory location comprising an address of the given allocation of the heap allocated memory is copied to a second memory location, the second memory location being different from the memory location.

8. The system of claim 6, further comprising software encoded in the computer readable medium and executable by the processor to cause the processor to:
decrement the reference count stored in the additional memory when a memory location comprising an address of the given allocation of the heap allocated memory is overwritten by another value, the value not being an address within the given allocation of the heap allocated memory.

9. The system of claim 6, further comprising software encoded in the computer readable medium and executable by the processor to cause the processor to:
decrement the reference count stored in the additional memory when a memory location comprising an address within the given allocation of the heap allocated memory is de-allocated.

10. The system of claim 6, further comprising software encoded in the computer readable medium and executable b the processor to cause the processor to:
when the iven allocation of the heap allocated memory is de-allocated, if any memory location in the heap allocated block that is to be de-allocated comprises an address of any other heap allocated block, decrement the reference count of the other heap allocated block.

11. A computer program product for dynamically pinpointing information relating to occurrences of memory leaks, the computer program product comprising a computer readable medium having a computer readable program comprising software, wherein the computer readable program when executed on a computer causes the computer to:
receive as input a first set of machine instructions executable by the computer and generate therefrom a second set of machine instructions from the first set of machine instructions in a main memory; and
while executing the second set of instructions:
to allocate an additional memor from a heap memory when the second set of instructions create a heap allocated memory, the additional memory being configured to store a reference count indicating a number of memory locations that comprise an address within the given allocation of heap allocated memory;
to modify the reference count when there is a use of an memory location second set of instructions, the modifying of the reference count being capable of including modification for a memory location that is not at the start of the given allocation of the heap allocated memory; and
to indicate a memory leak when a value associated with the reference count is zero.
